(19) United States
(12) Patent Application Publication
(10) Pub. No.: US 2009/0282841 A1
(43) Pub. Date: Nov. 19, 2009

(54) Cryopump

(75) Inventor: Hidekazu Tanaka, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: SUMITOMO HEAVY INDUSTRIES, LTD., Tokyo (JP)

(21) Appl. No.: 12/453,525

(22) Filed: May 14, 2009

(30) Foreign Application Priority Data
May 16, 2008 (JP) 2008-130138

(51) Int. Cl. B01D 8/00

(52) U.S. Cl. 62/55.5

(57) ABSTRACT

A cryopump includes: a refrigerator having a first cooling stage and a second cooling stage cooled to a temperature lower than that of the first cooling stage; a radiation shield on side surface of which is formed an opening, in which the refrigerator is inserted through the opening such that the first cooling stage is arranged outside and the second cooling stage is arranged inside, and which is thermally connected to the first cooling stage; and a refrigerator cover thermally connected to the second cooling stage, which extends through the opening from the inside to the outside of the radiation shield, and which is spaced apart from the radiation shield at the opening.

### BACKGROUND OF THE INVENTION

1. Field of the Invention

The present invention relates to a cryopump.

2. Description of the Related Art

A cryopump is a vacuum pump that captures and pumps gas molecules by condensing or adsorbing molecules on a cryopanel cooled to an extremely low temperature. The cryopump is generally used to achieve a clean vacuum environment required in a semiconductor circuit manufacturing process.

For example, Patent Document 1 describes a cryopump that has a plurality of strip-shaped panels provided in a radial pattern on the rear face of a heat shield panel with respect to the gas entering direction. The panels extend from the heat shield panel toward the rear face. The heat shield panel and the strip-shaped panels are connected to a second heat stage of a helium refrigerator. The second heat stage is provided at the tip of a second cooling tube extending from a first heat stage at the tip of a first cooling tube.

[Patent Document 1] Japanese Patent Application Laid-Open No. H2-308985.

However, in the aforementioned cryopump, a gas can be condensed on the surface of the second cooling tube. In this case, there is a fear that condensation and revaporization of a gas occurring due to temperature distribution between a temperature of the first heat stage and a temperature of the second heat stage on the surface of the second cooling tube may unstably vary a pressure inside the cryopump. It is preferable that such an unstable pressure variation is prevented. Also, it is preferable that a volume of gas captured and pumped in the cryopump is maximized.

### SUMMARY OF THE INVENTION

In view of these circumstances, a purpose of the present invention is to provide a cryopump in which an unstable pressure variation in the cryopump during an evacuation operation can be mitigated and a total amount of gas pumped in the cryopump can be maximized.

A cryopump according to an embodiment of the present invention comprises: a refrigerator including a first cooling stage and a second cooling stage cooled to a temperature lower than that of the first cooling stage; a radiation shield on side surface of which is formed an opening, in which the refrigerator is inserted through the opening such that the first cooling stage is arranged outside and the second cooling stage is arranged inside, and which is thermally connected to the first cooling stage; and a refrigerator cover thermally connected to the second cooling stage, which extends through the opening from the inside to the outside of the radiation shield, and which is spaced apart from the radiation shield at the opening.

According the embodiment, the refrigerator cover thermally connected to the second cooling stage and cooled to a low temperature, extends through the opening used for inserting the refrigerator from the inside to the outside of the radiation shield, and is arranged in the opening so as to be spaced apart from the radiation shield. Therefore, a large space for holding an ice layer generated by condensation of a gas can be secured on the refrigerator cover, allowing a gas pumping capacity of the cryopump to be increased. Further, because a gap is provided between the refrigerator cover and the radiation shield, it can be realized that the ice layer on the refrigerator cover is difficult to be in contact with the radiation shield. Thereby, it can be suppressed that a vacuum degree is decreased due to contact of the ice layer with the radiation shield.

The refrigerator may be arranged outside the radiation shield with the first cooling stage having an offset extending toward outside from the opening, and the refrigerator cover may have a terminal portion protruding by a length smaller than that of the offset, from the opening to the outside of the radiation shield.

A gap between the radiation shield and the refrigerator cover, and the length by which the refrigerator cover protrudes and extends from the opening, may be sized such that an ice layer accumulating on the refrigerator cover due to condensation of a gas is not in contact with the radiation shield and the first cooling stage before reaching a maximum pumping capacity of the cryopump.

The cryopump may further comprise a cryopanel thermally connected to the second cooling stage. A gap between the radiation shield and the refrigerator cover, and the length by which the refrigerator cover protrudes and extends from the opening, may be sized such that an ice layer accumulating on the refrigerator cover is not contact with the radiation shield and the first cooling stage, before a gas vapor pressure on the surface of an ice layer accumulating on the cryopanel due to condensation of a gas is higher than a recovery pressure set as a pressure to be reached within a predetermined period after gas flow into the cryopump has been stopped.

The refrigerator cover may be arranged such that the length by which the refrigerator cover protrudes and extends from the opening is equal to or larger than the gap between the radiation shield and the refrigerator cover.

The cryopump may further comprise a shielding member that surrounds the terminal portion and connects the first cooling stage and the radiation shield together. The shielding member may also be a heat transfer member thermally connecting the first cooling stage and the radial stage together.

A cryopump according to another embodiment of the present invention comprises: a radiation shield having a tubular side surface on which an opening is formed; a refrigerator including a first cooling stage cooled to a first temperature and thermally connected to the radiation shield, a second cooling stage cooled to a second temperature lower than the first temperature, and a connecting member connecting the first cooling stage and the second cooling stage together and having on its surface temperature distribution between the first temperature and the second temperature, the refrigerator inserted through the opening so as to arrange the second cooling stage inside the radiation shield; a refrigerator cover thermally connected to the second cooling stage and extending toward the first cooling stage along the surface of the connecting member; and an interference restraining structure defining a space that houses an ice layer accumulating on the refrigerator cover in a way that interference with the radiation shield is avoided, between the radiation shield and an end portion of the refrigerator cover adjacent to the first cooling stage.

The interference restraining structure may include a member protruding from the radiation shield so as to surround the connecting member and the end portion adjacent to the first cooling stage of the refrigerator cover.

### BRIEF DESCRIPTION OF THE DRAWINGS

FIG. 1 is a schematic diagram illustrating an embodiment of a cryopump;

FIG. 2 is a schematic diagram illustrating a cryopump during an evacuation operation;

FIG. 3 is a schematic diagram illustrating an cryopump according to an embodiment of the present invention; and

FIG. 4 is a schematic diagram illustrating a cryopump during an evacuation operation.

### DETAILED DESCRIPTION OF THE INVENTION

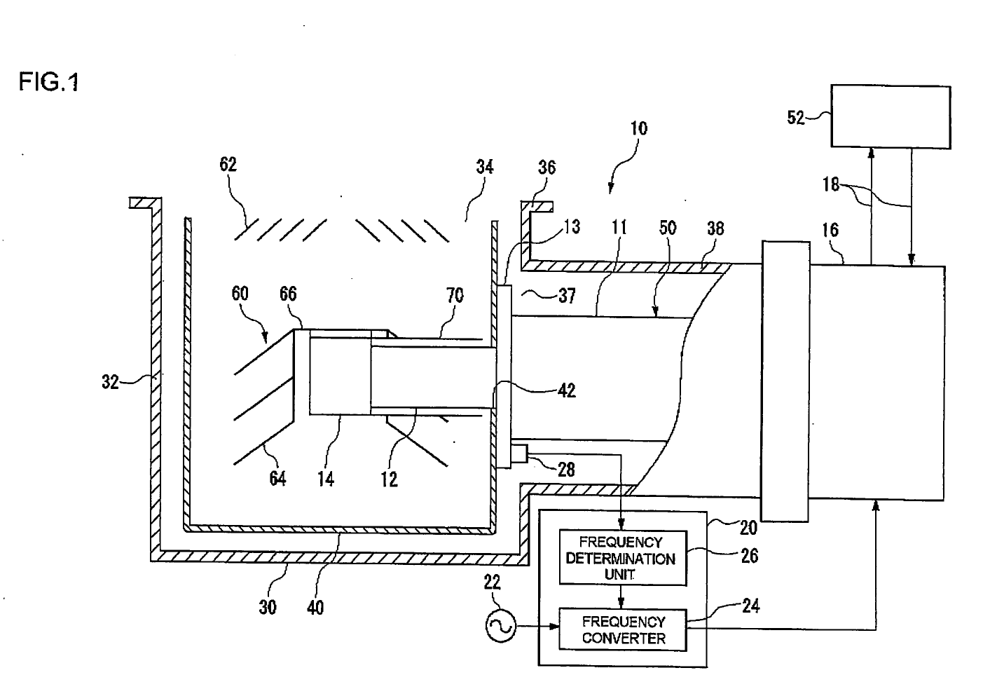

The invention will now be described by reference to the preferred embodiments. This does not intend to limit the scope of the present invention, but to exemplify the invention. FIG. 1 is a schematic diagram illustrating a cryopump 10. The cryopump 10 is mounted in a vacuum chamber of an apparatus, such as an ion implantation apparatus and a sputtering apparatus, that requires a high vacuum environment. The cryopump 10 is used to enhance the degree of vacuum in the vacuum chamber to a level required in a requested process. The cryopump 10 is configured to include a cryopump container 30, a radiation shield 40, and a refrigerator 50.

The refrigerator 50 is, for example, a Gifford-McMahon refrigerator (so-called GM refrigerator). The refrigerator 50 is provided with a first cylinder 11, a second cylinder 12, a first cooling stage 13, a second cooling stage 14 and a valve drive motor 16. The first cylinder 11 and the second cylinder 12 are connected in series. The first cooling stage 13 is arranged on the connected portion side of the first cylinder 11, which is connected with the second cylinder 12, and the second cooling stage 14 is arranged at the end of the second cylinder 12, which is on the side far from the first cylinder 11. The refrigerator 50 illustrated in FIG. 1 is a two-stage refrigerator in which a lower temperature is attained by combining two stage cylinders in series. The refrigerator 50 is connected to a compressor 52 through a refrigerant pipe 18.

The compressor 52 compresses a refrigerant gas such as helium, i.e., an operating gas, and supplies the gas to the refrigerator 50 through the refrigerant pipe 18. While cooling the operating gas by passing through a regenerator, the refrigerator 50 further cools the gas by expanding the gas in an expansion chamber inside the first cylinder 11 sequentially in that in the second cylinder 12. The regenerator are installed inside the expansion chambers. Thereby, the first cooling stage 13 arranged in the first cylinder 11 is cooled to a first cooling temperature level while the second cooling stage 14 arranged in the second cylinder 12 is cooled to a second cooling temperature level lower than the first cooling temperature level. For example, the first cooling stage 13 is cooled to about 65 K or 100 K while the second cooling stage 14 is about 10 K or 20 K.

A control unit 20 and an alternating current (AC) power source 22 are provided associated with the refrigerator 50. The control unit 20 includes a frequency converter 24 and a frequency determination unit 26. The control unit 20 may be configured to include a temperature sensor 28. The temperature sensor 28 is arranged in the first cooling stage of the refrigerator 50 to detect a temperature of the first cooling stage 13 and transmit the temperature information to the frequency determination unit 26. The place where the temperature sensor 28 is arranged is not limited to the first cooling stage 13, but any place, temperature of which is required to be controlled, such as any position in the second cooling stage 14, the first cylinder 11, or the second cylinder 12, is available. Alternatively, a plurality of temperature sensors 28 may be arranged in a plurality of places. Thereby, a temperature in each place can be controlled more finely.

The operating gas adsorbing heat by sequentially expanding in the expansion chambers to cool each cooling stage repasses through the regenerator, and is returned to a compressor 52 through the refrigerant pipe 18. Flow of the operating gas from the compressor 52 to the refrigerator 50 or vice versa is switched by a rotary valve (not illustrated) inside the refrigerator 50. A valve drive motor 16 rotates the rotary valve by supplying power from the AC power source 22.

The frequency converter 24 is provided between the valve drive motor 16 and the AC power source 22 so as to convert and outputs the frequency of the power supplied by the AC power source 22, and supplies it to the valve drive motor 16. The frequency determination unit 26 controls the frequency converter 24 based on the temperature information obtained from the temperature sensor 28. The frequency converter may be provided integratedly with the control unit 20 as illustrated, or provided separately therefrom.

The cryopump 10 illustrated in FIG. 1 is a so-called horizontal-type cryopump, where the second cooling stage 14 of the refrigerator is generally inserted inside the radiation shield 40 along the (usually orthogonal) direction intersecting with the axial direction of the tubular radiation shield 40. The present invention is also applicable to a so-called vertical-type cryopump alike, where the refrigerator is inserted along the axial direction of the radiation shield.

The cryopump container 30 has a portion formed into a cylindrical shape (hereinafter, referred to as a “trunk portion”) 32, one end of which is provided with an opening and the other end is occluded. The opening is provide as an intake vent 34 through which a gas to be pumped from the vacuum chamber in the sputtering apparatus and the like enters. The intake vent 34 is defined by the interior surface at the upper end of the trunk portion 32 of the cryopump container 30. In the trunk portion 32, also is formed an opening 37 for inserting the refrigerator 50. One end of the cylindrical-shaped refrigerator housing 38 is mounted in the opening 37 in the trunk portion 32 while the other end thereof is mounted in the housing of the refrigerator 50. The refrigerator housing 38 contains the first cylinder 11 of the refrigerator 50.

A mounting flange 36 extends toward the outside of the radial direction at the upper end of the trunk portion 32 of the cryopump container 30. The cryopump 10 is mounted in the vacuum chamber of the sputtering apparatus to be evacuated by using the mounting flange 36.

The cryopump container 30 is provided in order to separate the inside from the outside of the cryopump 10. As stated above, the cryopump container 30 is configured to include the trunk portion 32 and the refrigerator housing 38, insides of which are maintained at a common pressure in an airtight manner. The exterior surface of the cryopump container 30 is exposed to the outside environment of the cryopump 10 during an operation of the cryopump 10, i.e., during an operation of the refrigerator, and hence the surface is maintained at a temperature higher than that of the radiation shield 40. The temperature of the cryopump container 30 is typically maintained at an ambient temperature. Herein, the ambient temperature refers to a temperature of a place where the cryopump 10 is arranged or a temperature close to the temperature. The ambient temperature may be, for example, about room temperature.

The radiation shield 40 is arranged inside the cryopump container 30. The radiation shield 40 is formed into a cylindrical shape, one end of which is provided with an opening and the other end is occluded, that is, a cup-like shape. The radiation shield 40 may be formed as a one-piece cylinder as illustrated in FIG. 1. A plurality of parts may form a cylindrical shape as a whole. The plurality of parts may be provided so as to create a gap between the parts.

The trunk portion 32 of the cryopump container 30 and the radiation shield 40 are both formed into substantially cylindrical shapes and arranged concentrically. The inner diameter of the trunk portion 32 of the cryopump container 30 is slightly larger than the outer diameter of the radiation shield 40, therefore the radiation shield 40 is arranged in a non-contact state with the cryopump container 30, spaced slightly apart from the interior surface of the cryopump container 30. That is, the exterior surface of the radiation shield 40 faces the interior surface of the cryopump container 30. The trunk portion 32 of the cryopump container 30 and the radiation shield 40 are not limited to cylindrical in shapes but may be tubes having a rectangular, elliptical, or any other cross section. Typically, the shape of the radiation shield 40 is analogous to the shape of the interior surface of the trunk portion 32 of the cryopump container 30.

The radiation shield 40 is provided as a radiation shield to protect the second cooling stage 14 and a low temperature cryopanel 60 thermally connected to the second cooling stage 14 from heat radiation mainly from the cryopump container 30. The second cooling stage 14 is arranged substantially on the central axis of the radiation shield 40 in the inside space of the radiation shield 40. The radiation shield 40 is fixed to the first cooling stage 13 in a thermally connected state, and cooled to a temperature nearly equal to that of the first cooling stage 13.

The low temperature cryopanel 60 includes, for example, a plurality of panels 64. Each of the panels 64 has a shape of the side surface of a truncated corn, i.e., an umbrella-like shape. Each panel 64 is mounted in a panel mounting member 66 mounted in the second cooling stage 14. Typically, an adsorbent (not illustrated) such as activated carbon is provided in each panel 64. The adsorbent is adhered to, for example, the back face of the panel 64.

The panel mounting member 66 has a cylindrical shape, one end of which is occluded and the other end is opened. The occluded end portion is mounted at the upper end of the second cooling stage 14, cylindrical side surface of which extends toward the bottom of the radiation shield 40 so as to encompass the second cooling stage 14. The plurality of the panels 64 are mounted in the cylindrical side surface of the panel mounting member 66 to be spaced apart from each other. An opening for inserting the second cylinder 12 of the refrigerator 50 is formed on the cylindrical side surface of the panel mounting member 66.

A baffle 62 is provided in the intake vent of the radiation shield 40 in order to protect the second cooling stage 14 and the low temperature cryopanel 60 thermally connected thereto from heat radiation from the vacuum chamber, etc. The baffle 62 is formed into, for example, a louver structure or a chevron structure. The baffle 62 may be formed concentrically around the central axis of the radiation shield 40 or may be formed into other shapes such as a lattice shape, etc. The baffle 62 is mounted at the end portion on the opening side of the radiation shield 40 and cooled to a temperature nearly equal to that of the radiation shield 40.

A refrigerator mounting opening 42 is formed on the side surface of the radiation shield 40. The refrigerator mounting opening 42 is formed at the central portion of the side surface of the radiation shield 40 with respect to the central axis direction of the radiation shield 40. The refrigerator mounting opening 42 of the radiation shield 40 is provided coaxially with the opening 37 of the cryopump container 30. The second cylinder 12 and the second cooling stage 14 of the refrigerator 50 are inserted from the refrigerator mounting opening 42 along the direction perpendicular to the central axis direction of the radiation shield 40. The radiation shield 40 is fixed to the first cooling stage 13 in a thermally connected state, in the refrigerator mounting opening 42.

A refrigerator cover 70 surrounding the second cylinder 12 of the refrigerator 50 is provided in the cryopump 10. The refrigerator cover 70 is formed into a cylindrical shape with a diameter slightly larger than that of the second cylinder 12, one end of which is mounted in the second cooling stage 14 and the other end thereof extends toward the refrigerator mounting opening 42 of the radiation shield 40. There is provided a gap between the refrigerator cover 70 and the radiation shield 40, therefore the two are not in contact with each other. The refrigerator cover 70 is thermally connected to the second cooling stage 14 and cooled to a temperature equal to that of the second cooling stage 14.

The operation of the cryopump 10 with the aforementioned configuration will be described below.

The temperature sensor 28 measures a temperature of the first cooling stage 13 and transmits a measured result to the frequency determination unit 26. The frequency determination unit 26 determines a frequency based on the temperature information obtained from the temperature sensor 28. For example, if a temperature of the first cooling stage 13 obtained from the temperature sensor 28 is higher than a target temperature, the frequency determination unit 26 determines that an output frequency of the frequency converter 24 is to be increased while, if the temperature of the first cooling stage 13 is lower than the target temperature, the frequency determination unit 26 determines that the output frequency of the frequency converter 24 is to be decreased. Subsequently, the frequency determination unit 26 transmits a determination result to the frequency converter 24.

After receiving a signal from the frequency determination unit 26, the frequency converter 24 converts the frequency of the AC power source 22 to supply power to the valve drive motor 16. For example, if an output frequency is increased, a rotational speed of the valve drive motor 16 is increased, allowing the rotary valve to rotate at a higher speed. As a result, intake and exhaust of the operating gas in the refrigerator 50 is switched at a higher speed, allowing an intake and exhaust volume of the operating gas per unit time to be increased and an amount of heat adsorption by the operating gas per unit time also to be increased. Accordingly, the first cooling stage 13 can be cooled to the target temperature. Accordingly, the temperature of the second cooling stage 14 is further decreased with the cooling of the first cooling stage 13.

In contrast, if the temperature of the first cooling stage 13 is lower than a requested temperature, the frequency determination unit 26 determines that an output frequency of the frequency converter 24 is to be decreased. After receiving a signal from the frequency determination unit 26, the frequency converter 24 converts the power supplied by the AC power source 22 to power with a lower frequency and output the power. Thereby, a rotational speed of the valve drive motor 16 is slower, allowing an intake and exhaust cycle of the refrigerator 50 to take a longer period of time. Thereby, an intake and exhaust volume of the operating gas per unit time is decreased and the amount of heat adsorption by the gas per unit time is decreased as well. Accordingly, a temperature of the first cooling stage 13 is increased, and in response to that a temperature of the second cooling stage 14 is also increased.

As stated above, the control unit 20 controls a frequency of a refrigerating cycle of the refrigerator 50, and the first cooling stage 13 is adjusted such that a heat load by the radiation from the cryopump container 30 is balanced at the target temperature with an amount of heat adsorption by expansion of the operating gas.

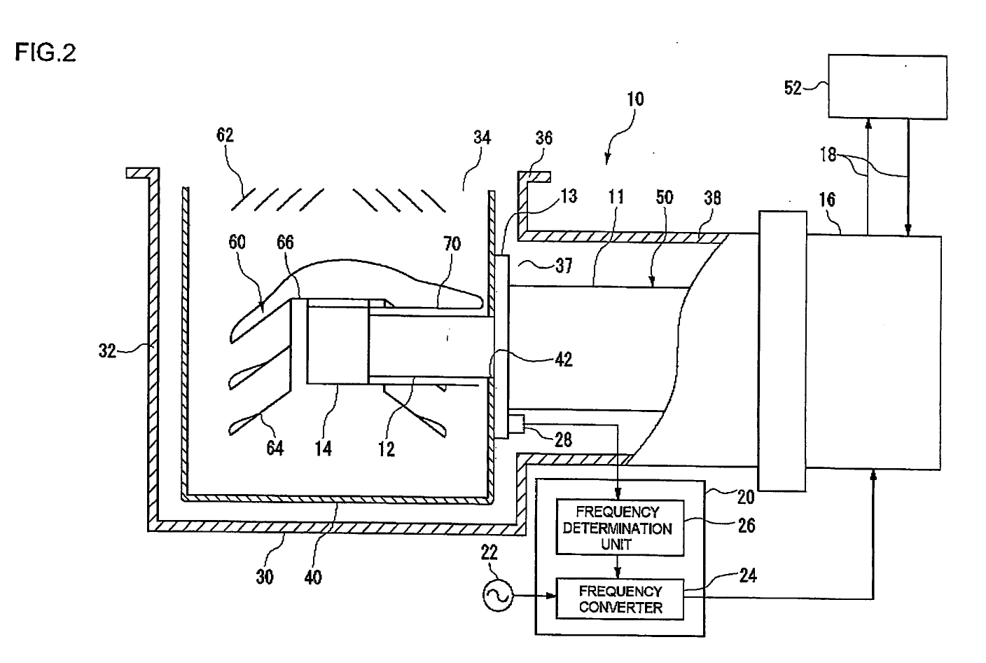

FIG. 2 is a schematic diagram illustrating the cryopump 10 during an evacuation operation. As illustrated in FIG. 2, an ice layer made of a condensed gas is deposited on the low temperature cryopanel 60 of the cryopump 10. When the volume to be evacuated of the cryopump 10 is, for example, a vacuum chamber of a sputtering apparatus, a major constituent of the ice layer is, for example, argon. The ice layer grows during an evacuation operation time, leading to increase in its thickness.

In the cryopump 10, not only the low temperature cryopanel 60 but also the refrigerator cover 70 are cooled by the second cooing stage 14, and hence an ice layer also accumulates on the refrigerator cover 70 due to condensation of the gas. Because the refrigerator cover 70 is capable of being used as part of the cryopanel, the total amount of gas captured and pumped in the cryopump 10 can be increased. Also, because the second cylinder 12 is covered by the refrigerator cover 70, formation of the ice layer on the second cylinder 12 can be restrained, allowing instability of the degree of vacuum to hardly occur.

The instability of the degree of vacuum would occur due to temperature gradient on the surface of the second cylinder 12. The temperature gradient occurs on the surface of the second cylinder 12 from the second cooling temperature of the second cooling stage 14 to the first cooling temperature of the first cooling stage 13. In the temperature range of the second cooling temperature to the first cooling temperature, the boiling point of a gas (e.g., argon) condensed on the low temperature cryopanel 60 is included. Therefore, a position, temperature of which is equal to the boiling temperature of the gas, is present on the surface of the second cylinder 12. Because a heat load on the low temperature cryopanel 60 is increased as the ice layer accumulates on the low temperature cryopanel 60, a temperature of the low temperature cryopanel 60 can also vary. Accordingly, the position equal to the boiling temperature of the gas on the surface of the second cylinder 12 moves (from side to side in the drawing).

As a result, if there is no refrigerator cover 70 such that the second cylinder 12 is exposed, part of the ice layer accumulating on the second cylinder 12 is rapidly vaporized by a temperature change on the surface of the second cylinder 12, causing the degree of vacuum to be deteriorated. For example, if a temperature of the second cooling stage 14 is increased such that the position equal to the boiling point of the gas moves in the direction towards the second cooling stage 14, the gas condensed at the original position equal to the boiling temperature of the gas cannot maintain the condensed state, leading to rapid vaporization of the gas.

Even if the refrigerator cover 70 is provided, the same phenomenon can occur. It is the case where the ice layer accumulating on the refrigerator cover 70 is in contact with the radiation shield 40. The end portion of the refrigerator cover 70 is adjacent to the radiation shield 40 so as to minimize exposure of the surface of the second cylinder 12. Therefore, if the ice layer grows at the end portion of the refrigerator cover 70 adjacent to the radiation shield 40, the ice layer can be in contact with the radiation shield 40. The ice layer in contact with the radiation shield 40 is to be heated by the radiation shield 40, and accordingly is rapidly vaporized. In this case, it is difficult that the cryopump 10 further enhances the degree of vacuum. Therefore, the maximum pumping capacity of the cryopump 10 is determined by a gas pumping capacity at the time when the ice layer accumulating on the refrigerator cover 70 is in contact with the radiation shield 40.

If the ice layer is not in contact with the radiation shield 40, a larger pumping capacity can be realized in principle. In principle, the cryopump 10 can perform evacuation before a vapor pressure on the surface of the ice layer accumulating on the low temperature cryopanel 60 exceeds the degree of vacuum to be attained. When the vapor pressure on the surface of the ice layer exceeds the degree of vacuum to be attained, vaporization from the ice layer is predominant over gas condensation from ambient atmosphere to the ice layer, and hence further evacuation cannot be performed. There occurs temperature distribution in which temperature gradually rises from the surface of the cryopanel to the surface of the ice layer, and a gas vapor pressure on the surface of the ice layer is determined by the temperature of the surface of ice layer. Therefore, the gas pumping capacity of the cryopump 10 at the time when the ice layer grows such that its thickness is large and when a vapor pressure on the surface of the ice layer exceeds the degree of vacuum to be attained, becomes the maximum pumping capacity under the given low temperature cryopanel 60. If the ice layer is in contact with the radiation shield 40 before reaching the maximum pumping capacity, only a maximum pumping capacity smaller than the above potential maximum pumping capacity is obtained.

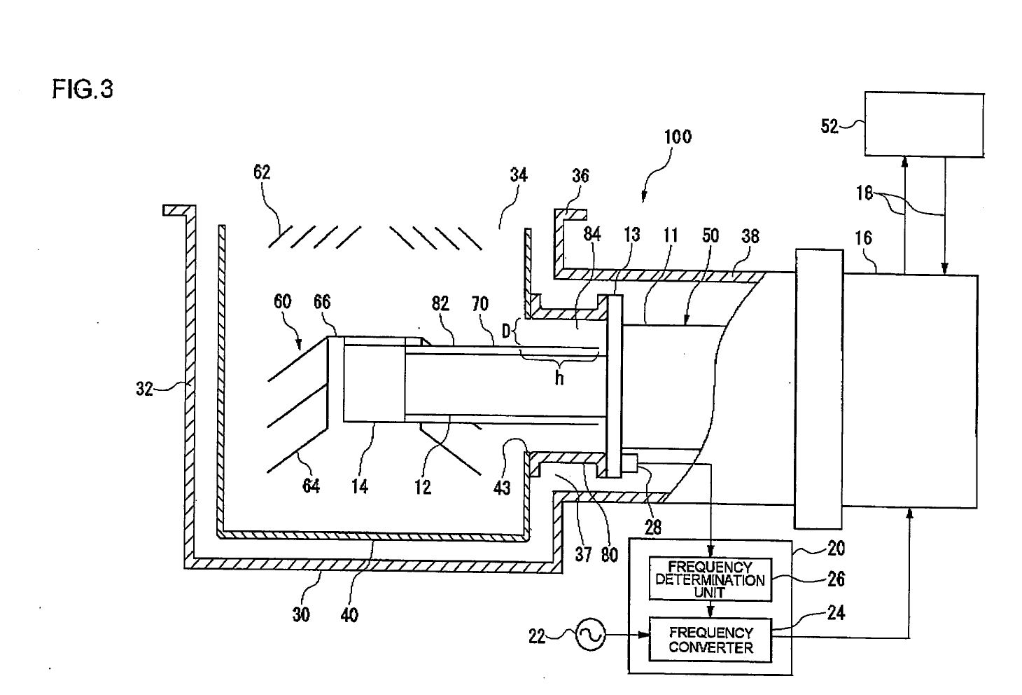

FIG. 3 is a schematic diagram illustrating the cryopump 100 according to an embodiment of the present invention. The cryopump 100 illustrated in FIG. 3 differs from the cryopump 10 illustrated in FIG. 1 in that the radiation shield 40 is connected to the first cooling stage 13 through a first heat transfer sleeve 80 used for heat transfer. Also, the cryopump 100 differs therefrom in that a second sleeve 82, as the refrigerator cover 70, penetrates and extends through the radiation shield 40. In the following description, descriptions with respect to the common portions between the cryopump 100 illustrated in FIG. 3 and the cryopump 10 illustrated in FIG. 1 will be appropriately omitted for simplicity of explanation.

The cryopump 100 comprises an interference restraining structure to avoid interference between the ice layer accumulating on the refrigerator cover 70 and the radiation shield 40. The interference restraining structure has, for example, a double sleeve arrangement extending along the axial direction of the refrigerator 50. The cryopump 100 has a frost accommodating space 84 for accommodating a distal end of an ice layer made of a condensed gas is formed between a first sleeve 80 and a second sleeve 82, which configure the double sleeve arrangement. The frost accommodating space 84 is sized such that the ice layer is not in contact with a portion cooled to the first cooling temperature until the maximum pumping capacity of the cryopump 100 has been reached. The ice layer accumulating on the refrigerator cover 70 is housed in the frost accommodating space 84, avoiding the interference with the radiation shield 40. That is, the frost accommodating space 84 is sized such that a gap between the ice layer accumulating on the portion cooled to the second cooling temperature and the portion cooled to the first cooling temperature, is maintained before reaching the maximum pumping capacity.

A refrigerator insertion opening 43 is provided on the side surface of the radiation shield 40. The refrigerator insertion opening 43 is provided at a position corresponding to the opening 37 in the trunk portion 32 of the cryopump container 30. The refrigerator insertion opening 43 is formed coaxially with the opening 37 and formed so as to have a diameter smaller than that of opening 37.

The refrigerator 50 is arranged to be inserted through the refrigerator insertion opening 43 and the opening 37. The refrigerator 50 is inserted through the refrigerator insertion opening 43 such that the second cooling stage 14 is arranged so as to be surrounded by the inside of the radiation shield 40, and the first cooling stage 13 is arranged inside the refrigerator housing 38 of the cryopump container 30, in the outside of the radiation shield 40. Therefore, the first cooling stage 13 is located outside the radiation shield 40 with an offset extending outwards between the first cooling stage 13 and the radiation shield 40. The diameters of the opening 37 in the cryopump container 30 and the refrigerator housing 38 are larger than that of the first cooling stage 13. Hence, it is possible that the first cooling stage 13 is arranged at any position inside the refrigerator housing 38 with respect to the longitudinal direction of the refrigerator 50. Accordingly, a desired length of the offset between the first cooling stage 13 and the radiation shield 40 can be selected. The second cylinder 12 and the refrigerator cover 70 pass through the refrigerator insertion opening 43 and the opening 37 such that the second cylinder 12 and the refrigerator cover 70 intersect with the side surface of the radiation shield 40.

The radiation shield 40 is fixed and thermally connected to the first cooling stage 13 by the first sleeve 80. The first sleeve 80 is formed into a cylindrical shape, on both ends of which flange portions are provided so as to be mounted to each of the radiation shield 40 and the first cooling stage 13 with bolts, etc. The first sleeve 80 extends toward the second cooling stage 14 from the first cooling stage 13 to the radiation shield 40. The diameter of the first sleeve 80 is the same as that of the refrigerator insertion opening 43 in the radiation shield 40, and the length thereof is equal to that of the offset between the radiation shield 40 and the first cooling stage 13. The first sleeve 80 is a heat transfer member thermally connecting the first cooling stage 13 to the radiation shield 40. The thickness of the first sleeve 80 may be larger than that of the radiation shield 40 in consideration of, for example, heat transfer characteristic. In addition, the first sleeve 80 is formed into a tubular shape so as to surround the second sleeve 82 cooled to a lower temperature, and hence the first sleeve also serves as part of a radiation shield shielding heat radiation transferred to the second sleeve 82 from outside.

Because the first cooling stage 13 is spaced apart from the radiation shield 40 outside the radiation shield 40, the length of the second cylinder is relatively large. The length of the second cylinder 12 becomes longer by the length of the offset between the first cooling stage 13 and the radiation shield 40, as compared to the case where the first cooling stage 13 is directly mounted to the radiation shield 40. Because the second cylinder 12 has a longer length, a temperature difference between the first cooling stage 13 and the second cooling stage 14 can be larger. Accordingly, in case that a cooling temperature of the first cooling stage 13 is set to a predetermined target temperature, a cooling temperature of the second cooling stage 14 can be lower. As a result, the cryopanel 60 can be cooled to a lower temperature, allowing the gas pumping capacity of the cryopump 100 to be increased.

In a multi-stage refrigerator, a certain relationship is held among temperatures of the respective cooling stages. For example, in a two-stage refrigerator, when a temperature of one of the first cooling stage 13 and the second cooling stage 14 is determined under a certain condition, a temperature of the other is uniquely determined. For example, when maintaining the first cooling stage 13 at a requested target temperature, a temperature of the second cooling stage 14 is uniquely determined under a certain condition. Herein, a minimum load state is assumed as the certain condition. The minimum load state refers to a state where, during an operation of the cryopump 10, a load exerted on each cooling stage is a minimum and a cooling temperature of the second cooling stage 14 can be maintained at the lowest temperature. Herein, the case will be considered where the second cooling stage 14 is preferably cooled to a temperature equal to or lower than a requested temperature while maintaining the first cooling stage 13 at a requested target temperature.

If the requested temperature is lower than the temperature of the second cooling stage 14, which is uniquely determined when the first cooling stage 13 is maintained at the target temperature in the minimum load state, it is impossible that the second cooling stage 14 is cooled to a temperature lower than the requested temperature while maintaining the first cooling stage 13 at the target temperature. In this case, the temperature of the second cooling stage 14 can be lower if an intake and exhaust cycle in the refrigerator 50 is made shorter; however, the temperature of the first cooling stage 13 is also lower than the target temperature. To deal with the problem, in the present invention, the length of the offset between the radiation shield 40 and the first cooling stage 13, that is, the length of the second cylinder 12, is adjusted such that the second cooling stage is cooled to a temperature equal to or lower than the requested temperature when the first cooling stage 13 is cooled to the target temperature. Thereby, it can be realized that the second cooling stage 14 is cooled to a temperature equal to or lower than the requested temperature while maintaining the temperature of the first cooling stage at the requested target temperature.

A state where temperatures of the first cooling stage 13 and the second cooling stage 14 fall within requested temperature ranges can be realized by, for example, using a refrigerator, refrigerating capacity of which is above what is necessary, such that the temperatures of the first and second cooling stages 13 and 14 are adjusted by heating them with heaters, respectively. In this case, however, the cooling stages are excessively cooled and then heated, causing energy saving property to be deteriorated. In contrast, according to the present embodiment, the temperatures of the first cooling stage 13 and the second cooling stage 14 can be made fall in the requested temperature ranges by adjusting the cylinder length without the use of a heater, allowing a cryopump excellent in the energy saving property to be provided.

The second sleeve 82, as the refrigerator cover 70, penetrates and extends through the radiation shield 40 from the second cooling stage 14 toward the first cooling stage 13. A clearance with a width of D is provided between the second sleeve 82 and the radiation shield 40. The second sleeve 82 is formed into a cylindrical shape so as to surround almost the whole of the second cylinder 12. The second sleeve 82 extends by a length of h from the refrigerator insertion opening 43 to the outside of the radiation shield 40. The second sleeve 82 extends to the near side of the first cooing stage 13 such that there is a gap between the second sleeve 82 and the first cooling stage 13, allowing the sleeve not to be in contact with the first cooling stage 13. For example, it is preferable that the length of the second sleeve 82 is determined such that the terminal portion of the sleeve 82 is not seen when viewed from outside the cryopump.

The radial of the second sleeve 82 is smaller than that of the first sleeve 80 by a length of D. Therefore, at the end portion on the first cooling stage 13 side of the second sleeve 82, the annular frost accommodating space 84 with a length of h and a diameter of D is formed inside the first sleeve 80. The length h is preferably set to the length equal to or larger than D. For example, the length h may be set to four times or more of the length D. As stated above, it can be realized that the ice layer is difficult to be in contact with the first cooling stage 13 by making the length h relatively long.

The frost accommodating space 84 is sized such that the ice layer accumulating on the second sleeve 82 is not in contact with a portion cooled to the first cooling temperature before the gas pumping capacity of the cryopump 100 reaches the maximum pumping capacity. That is, the frost accommodating space 84 is sized such that the ice layer accumulating on the second sleeve 82 is not in contact with the radiation shield 40, the first sleeve 80, and the first cooling stage 13. The frost accommodating space 84 is a concavity formed on the interior surface of the radiation shield 40. Therefore, gas molecules are difficult to reach the frost accommodating space 84 from the intake vent of the cryopump 100. It can be suppressed that gas molecules enter the frost accommodating space 84 by forming the space 84 so as to be a concavity when viewed from the intake vent 34, allowing an accumulation rate of the ice layer in the frost accommodating space 84 to be small. Hence, a period before the ice layer reaches the portion cooled to the first cooling temperature can be made long, allowing an evacuation operation of the cryopump 100 to be continued for a long time.

The maximum pumping capacity is, for example, a maximum total amount of gas captured and pumped in the cryopump 100 in which the requested degree of vacuum is realized in the cryopump container 30. In addition, the maximum pumping capacity is, for example, a total amount of gas pumped at the time when a gas vapor pressure on the surface of the ice layer accumulating on the low temperature cryopanel 60 is equal to the requested degree of vacuum. Herein, the requested degree of vacuum may be a recovery pressure set as a pressure to be reached within a predetermined period after gas flow into the cryopump 100 has been stopped.

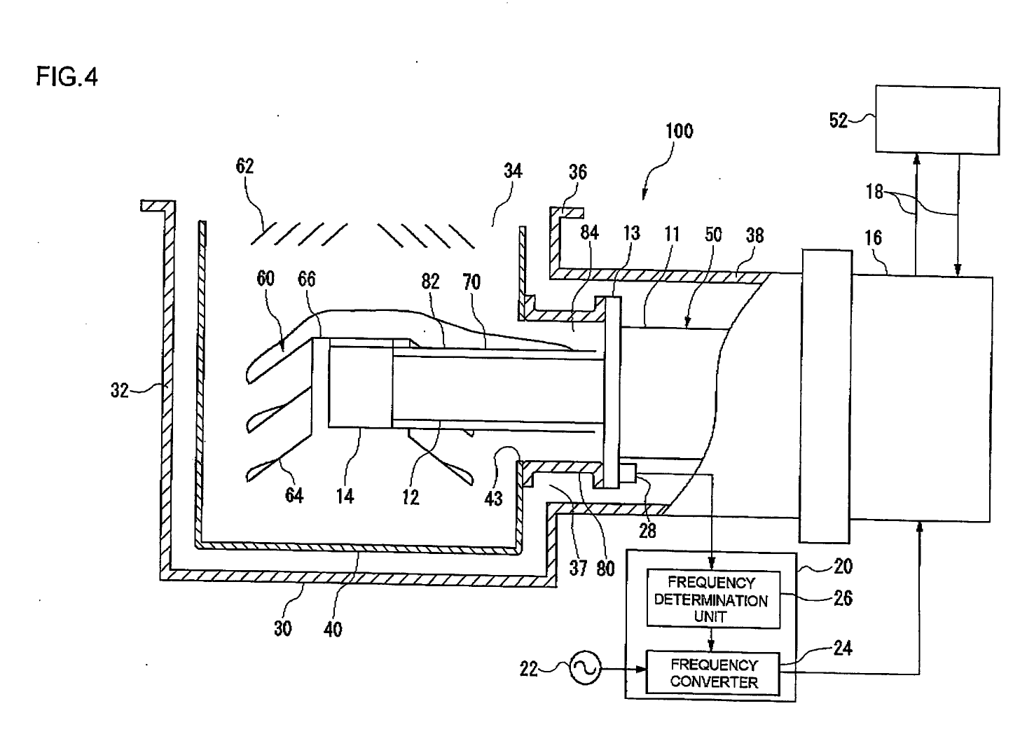

FIG. 4 is a schematic diagram illustrating the cryopump 100 during an evacuation operation. As illustrated in FIG. 4, an ice layer made of a condensed gas accumulates on the low temperature cryopanel 60 of the cryopump 100. When the volume to be evacuated of the cryopump 10 is, for example, a vacuum chamber of a sputtering apparatus, a major constituent of the ice layer is, for example, argon. The ice layer grows with a lapse of evacuation operation time, leading to increase in its thickness. The evacuation operation can be continued before the vapor pressure on the surface of the ice layers exceeds the recovery pressure due to the temperature gradient occurring in the thickness direction of the ice layer.

According to the present embodiment, the ice layer can also be accommodated in the frost accommodating space 84 as illustrated in the drawing; hence, a gas pumping capacity of the cryopump 100 can be increased. As the frost accommodating space 84 is set such that the ice layer is not in contact with the radiation shield 40 or the first cooling stage 13 before reaching the maximum pumping capacity of the cryopump 100; hence, the maximum pumping capacity possibly enjoyed in principle can be realized with respect to the low temperature cryopanel 60 mounted. Further, because the second cylinder 12 can be made long by providing the offset between the radiation shield 40 and the first cooling stage 13, the low temperature cryopanel 60 can be cooled to a lower temperature. This also contributes to the increase in the pumping capacity of the cryopump 100.

The present invention has been described above based on the embodiments. It should be appreciated by those skilled in the art that the invention is not limited to the above embodiments but various design changes and variations can be made, and such variations are also encompassed by the present invention.

For example, the radiation shield 40 and the first sleeve 80 are formed as separate members but not limited thereto. The radiation shield 40 and the heat transfer member may be formed integratedly with each other. In this case, the radiation shield 40 may be provided with a heat transfer portion that extends from the side surface of the radiation shield 40 toward the outside of the radiation shield 40 along the refrigerator 50, and that is mounted in the first cooling stage 13.

The first sleeve 80, as a heat transfer member, has a cylindrical shape but may have any shape with a structure connecting the radiation shield 40 and the first cooling stage 13 together. For example, the heat transfer member may have a shape of the side surface of a truncated corn in which the diameter of the first sleeve 80 becomes smaller when progressively drawing outwards away from the refrigerator insertion opening 43 in the radiation shield 40. According to the shape, the frost accommodating space 84 can be relatively large in the vicinity of the refrigerator insertion opening 43; hence, it can be realized that the ice layer is difficult to be in contact with the radiation shield 40 or the first sleeve 80. Alternatively, the heat transfer member may protrude inside the radiation shield 40.

The refrigerator cover 70 and the second sleeve 82 may not necessarily cover the whole second cylinder 12. The shapes of the refrigerator cover 70 and the second sleeve 82 may be determined such that the two cover at least a portion of the surface of the second cylinder 12, temperature of which varies within a temperature range including the boiling point of a gas to be pumped (e.g., the central portion of the second sleeve 82). According to the shapes, the surface of the second cylinder 12, which is not covered by the refrigerator cover 70, has a temperature that is always either considerably lower or considerably higher than the boiling point of the gas to be pumped. Accordingly, it can be ensured that the ice layer accumulating on the surface of the second cylinder 12 does not cause pressure instability.

Alternatively, the shapes of the refrigerator cover 70 and the second sleeve 82 may be determined such that the surface of the second cylinder 12, which is exposed when viewed from the intake vent of the cryopump 100, is shielded. According to the shapes, it can be avoided by the refrigerator cover 70 that the gas molecules entering from the intake vent of the cryopump 100 directly reach the surface of the second cylinder 12. Therefore, accumulation of the ice layer on the surface of the second cylinder 12 can be reduced.

It is preferable that the lengths of the refrigerator cover 70 and the second sleeve 82 are determined such that the temperature at the terminal portion is lower than the boiling point of a gas to be pumped. On the surface of the refrigerator cover 70, there can occur a temperature gradient to some degree and the temperature can become higher when progressively drawing away from the second cooling stage 14. Hence, by determining the lengths thereof such that temperature at the terminal portion is sufficiently low, the gas can be condensed by maintaining the whole refrigerator cover 70 at a temperature lower than the boiling point of the gas to be pumped. Alternatively, the refrigerator 50 may be configures and arranged such that temperature at the terminal portion of the refrigerator cover 70 and the second sleeve 82 is lower than the boiling point of the gas to be pumped.

The refrigerator cover 70 and the second sleeve 82 may not be cooled to a temperature equal to that of the second cooling stage 14 of the refrigerator 50. For example, the refrigerator cover 70 may be thermally connected to the second cylinder 12 of the refrigerator 50. In this case, the portion of the second cylinder 12, to which the refrigerator cover 70 is connected, is preferably selected from the portions, at temperatures of which the gas to be pumped maintains a solid state.

What is claimed is:

1. A cryopump comprising:
a refrigerator including a first cooling stage and a second cooling stage cooled to a temperature lower than that of the first cooling stage;
a radiation shield on side surface of which is formed an opening, in which the refrigerator is inserted through the opening such that the first cooling stage is arranged outside and the second cooling stage is arranged inside, and which is thermally connected to the first cooling stage; and
a refrigerator cover thermally connected to the second cooling stage, which extends through the opening from the inside to the outside of the radiation shield, and which is spaced apart from the radiation shield at the opening.

2. The cryopump according to claim 1, wherein the refrigerator is arranged outside the radiation shield with the first cooling stage having an offset extending toward outside from the opening, and
wherein the refrigerator cover has a terminal portion protruding by a length smaller than that of the offset, from the opening to the outside of the radiation shield.

3. The cryopump according to claim 2, wherein a gap between the radiation shield and the refrigerator cover, and the length by which the refrigerator cover protrudes and extends from the opening, are sized such that an ice layer accumulating on the refrigerator cover due to condensation of a gas is not in contact with the radiation shield and the first cooling stage before reaching a maximum pumping capacity of the cryopump.

4. The cryopump according to claim 2 further comprising a cryopanel thermally connected to the second cooling stage, wherein a gap between the radiation shield and the refrigerator cover, and the length by which the refrigerator cover protrudes and extends from the opening, are sized such that an ice layer accumulating on the refrigerator cover is not in contact with the radiation shield and the first cooling stage, before a gas vapor pressure on a surface of the ice layer accumulating on the cryopanel due to condensation of a gas is higher than a recovery pressure set as a pressure to be reached within a predetermined period after gas flow into the cryopump has been stopped.

5. The cryopump according to claim 2, wherein the refrigerator cover is arranged such that the length by which the refrigerator cover protrudes and extends from the opening is equal to or larger than a gap between the radiation shield and the refrigerator cover.

6. The cryopump according to claim 2 further comprising a shielding member that surrounds the terminal portion and connects the first cooling stage and the radiation shield together.

7. A cryopump comprising:
a radiation shield having a tubular side surface on which an opening is formed;
a refrigerator including a first cooling stage cooled to a first temperature and thermally connected to the radiation shield; a second cooling stage cooled to a second temperature lower than the first temperature; and a connecting member connecting the first cooling stage and the second cooling stage together and having on its surface temperature distribution between the first temperature and the second temperature, the refrigerator inserted through the opening so as to arrange the second cooling stage inside the radiation shield;
a refrigerator cover thermally connected to the second cooling stage and extending toward the first cooling stage along the surface of the connecting member; and
an interference restraining structure defining a space that houses an ice layer deposited on the refrigerator cover in a way that interference with the radiation shield is avoided, between the radiation shield and an end portion of the refrigerator cover adjacent to the first cooling stage.

8. The cryopump according to claim 7, wherein the interference restraining structure includes a member protruding from the radiation shield so as to surround the connecting member and the end portion adjacent to the first cooling stage of the refrigerator cover.
